(19) United States
(12) Patent Application Publication
(10) Pub. No.: US 2026/0326451 A1
(43) Pub. Date: Oct. 22, 2026

(54) PRESSURE MEASUREMENT APPARATUS AND RECORDING APPARATUS PROVIDED WITH THE SAME

(71) Applicant: KYOCERA CORPORATION, Kyoto-shi, Kyoto (JP)

(72) Inventor: Daisuke ETO, Nishi-ku, Osaka-shi, Osaka (JP)

(21) Appl. No.: 19/110,425

(22) PCT Filed: Sep. 6, 2023
(86) PCT No.: PCT/JP2023/032582

§ 371 Date: Mar. 11, 2025

(30) Foreign Application Priority Data
Sep. 14, 2022 (JP) 2022-146074

(51) Int. Cl. B41J 2/175; B41J 2/185; B41J 11/00; B41J 25/00

(52) U.S. Cl. CPC B41J 2/17556; B41J 2/17563; B41J 2/185; B41J 11/0015; B41J 25/001

(57) ABSTRACT

A pressure measurement apparatus for measuring a pressure in a plurality of pressure transmission paths that apply pressure to an object via a gas, includes at least one pressure measurement section, including a measurement path with an internal space configured to receive the gas; and a pressure sensor configured to detect the pressure in the internal space; and at least one switching section configured to selectively switch a connection destination of the measurement path from among the plurality of pressure transmission paths.

### CROSS-REFERENCE TO RELATED APPLICATION

The present application is a National Phase of International Application No. PCT/JP2023/032582 filed Sep. 6, 2023, which claims priority to Japanese Patent Application No. 2022-146074, filed on Sep. 14, 2022.

### TECHNICAL FIELD

The present disclosure relates to a pressure measurement apparatus and a recording apparatus provided with the same.

### BACKGROUND OF INVENTION

Patent Document 1 discloses a recording apparatus including a liquid ejection mechanism for forming an image by ejecting liquid onto a recording medium. The liquid ejection mechanism includes a liquid ejection head, a moving table supporting the liquid ejection head and movable in the main scanning direction, and a pressure measurement apparatus arranged on the moving table. The pressure measurement apparatus measures the pressure of the liquid inside the liquid ejection head, and includes a pressure transmission path communicating with the liquid ejection head, and a pressure sensor capable of measuring the pressure of the pressure transmission path.

### CITATION LIST

### Patent Literature

Patent Document 1: JP 2010-52357 A

### SUMMARY

It is an object of the present disclosure to provide a pressure measurement apparatus capable of measuring the pressure in pressure transmission paths by a number of pressure sensors smaller than the number of pressure transmission paths, and a recording apparatus provided with this pressure measurement apparatus.

A pressure measurement apparatus according to one aspect of the present disclosure is a pressure measurement apparatus for measuring a pressure in a plurality of pressure transmission paths that apply pressure to an object via a gas. The apparatus includes at least one pressure measurement section including a measurement path with an internal space configured to receive the gas, and a pressure sensor configured to detect the pressure in the internal space, and at least one switching section configured to selectively switch a connection destination of the measurement path from among the plurality of pressure transmission paths.

A recording apparatus according to another aspect of the present disclosure, includes the pressure measurement apparatus described above, the plurality of pressure transmission paths, and at least one liquid ejection section configured to eject a liquid onto a recording material. Each of the plurality of pressure transmission paths is configured to apply the pressure to the liquid that is supplied to or recovered from the at least one liquid ejection section.

### BRIEF DESCRIPTION OF THE DRAWINGS

FIG. 1 is a perspective view illustrating the overall configuration of a recording apparatus according to an embodiment of the present disclosure.

FIG. 2 is a schematic cross-sectional view of a line II-II in FIG. 1.

FIG. 3 is an enlarged perspective view of a carriage illustrated in FIG. 1.

FIG. 4 is a schematic view illustrating a plurality of pressure transmission paths around the carriage according to an embodiment of the present disclosure.

FIG. 5 is a schematic view illustrating a supply sub-tank and a recovery sub-tank according to an embodiment of the present disclosure.

FIG. 6 is a schematic view illustrating the flow of liquid around a liquid ejection head according to an embodiment of the present disclosure.

FIG. 7 is a schematic view illustrating a state during liquid ejection corresponding to FIG. 4.

FIG. 8 is a schematic view illustrating a state during a purge operation corresponding to FIG. 4.

### DESCRIPTION OF EMBODIMENTS

A pressure measurement apparatus and a recording apparatus according to each embodiment of the present disclosure, will be described below with reference to the drawings. The following embodiments will exemplify an ink jet printer as a specific example of a recording apparatus, equipped with an ink head to eject ink for image formation on a wide and long recording medium. The ink jet printer is suitable for digital textile printing in which images such as letters and patterns are printed on a recording medium made of fabric such as textile or knitted fabric by an inkjet method. Of course, the recording apparatus according to the present disclosure can also be used for printing various images on a recording medium such as a paper sheet or a resin sheet.

### Overall Configuration of Ink Jet Printer

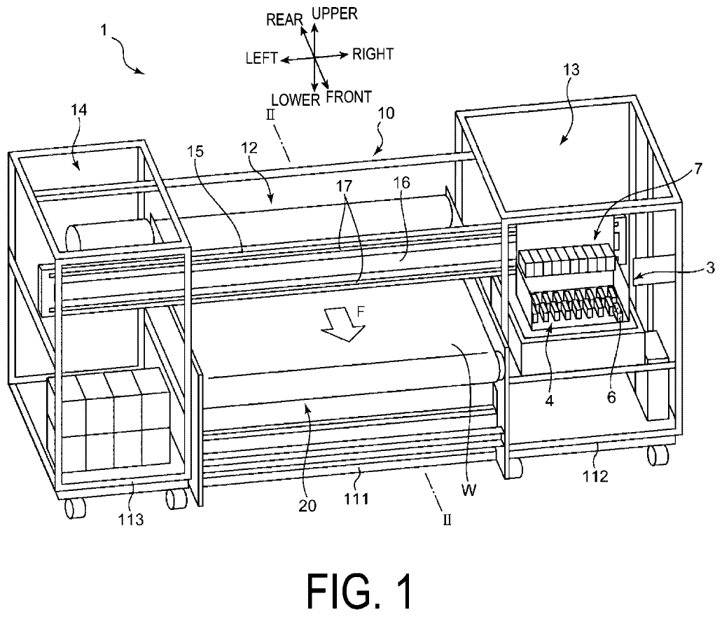

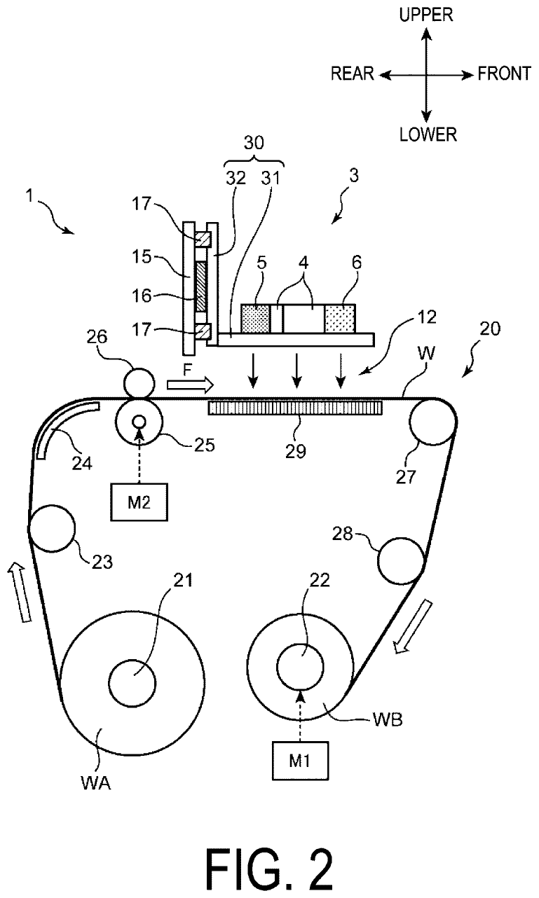

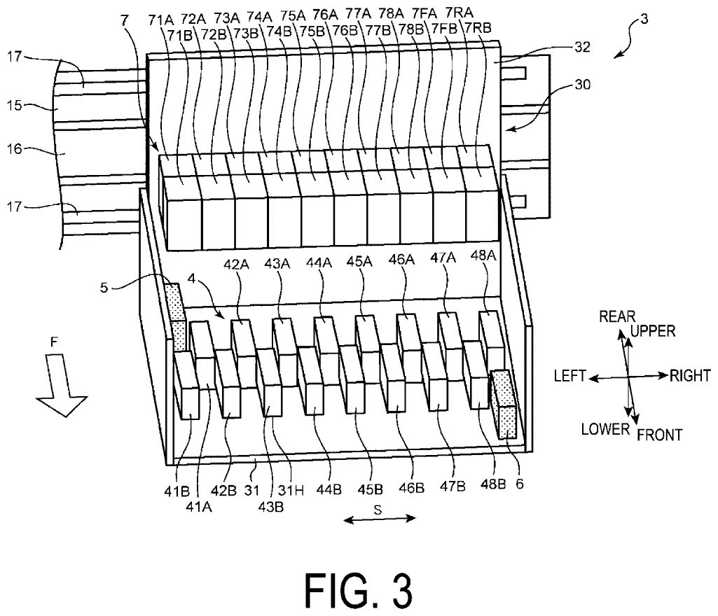

FIG. 1 is a perspective view illustrating the overall configuration of an ink jet printer 1 according to a first embodiment of the present disclosure. FIG. 2 is a schematic cross-sectional view of a line II-II in FIG. 1. The ink jet printer 1 is a printer that prints images on a wide and long workpiece W (recording medium) by an inkjet method, and includes an apparatus frame 10, a workpiece conveyance section 20 (conveyance section) and a carriage 3 incorporated in the apparatus frame 10. In the present embodiment, the left-right direction is a main scanning direction S for printing the workpiece W (FIG. 3), and a rearward to forward direction is a sub scanning direction (conveyance direction F of the workpiece W, which is a direction intersecting the main scanning direction S).

The apparatus frame 10 forms a framework for mounting various components of the ink jet printer 1. The workpiece conveyance section 20 is a mechanism for intermittently feeding (conveying) the workpiece W so as to advance in the conveyance direction F from the rearward to forward direction in a printing area where the inkjet printing process is performed. An ink head 4, a pre-treatment liquid head 5, a post-treatment liquid head 6, and a sub-tank 7 are mounted on the carriage 3, and the carriage 3 reciprocates in the main scanning direction S (left-right direction) crossing the conveyance direction F of the workpiece W during an inkjet printing process.

The apparatus frame 10 includes a central frame 111, a right frame 112, and a left frame 113. The central frame 111 forms a framework for mounting the various components of the ink jet printer 1, and has a left-right width corresponding to the workpiece conveyance section 20. The right frame 112 and the left frame 113 are erected to the right and left of the central frame 111, respectively. The space between the right frame 112 and the left frame 113 is the printing area 12 where the printing process is executed for the workpiece W.

The right frame 112 forms a maintenance area 13. The maintenance area 13 is an area where the carriage 3 is retracted when the printing process is not executed. In the maintenance area 13, the nozzles (discharge holes) of the ink head 4, pre-treatment liquid head 5 and post-treatment liquid head 6 are cleaned and purged, and the caps are fitted. The left frame 113 forms a return area 14 of the carriage 3. The return area 14 is an area where the carriage 3, which has mainly scanned the printing area 12 from the right to the left in the printing process, temporarily enters when performing main scanning in the reverse direction.

A carriage guide 15 for causing the carriage 3 to reciprocate in the left-right direction, is mounted on the upper side of the apparatus frame 10. The carriage guide 15 is a plate shaped member that is long in the left-right direction and is arranged above the workpiece conveyance section 20. A timing belt 16 is attached to the carriage guide 15 so as to be movable around in the left-right direction (main scanning direction). The timing belt 16 is an endless belt and is driven to move around in the left direction or the right direction.

The carriage guide 15 is equipped with a pair of upper and lower guide rails 17, which extend in parallel in the left-right direction and hold the carriage 3 so as to be capable of reciprocating in the main scanning direction S. The carriage 3 is engaged with the guide rails 17. The carriage 3 is fixed to the timing belt 16. The carriage 3 moves in the left or right direction along the carriage guide 15 while being guided by the guide rails 17 as the timing belt 16 moves in the left or right direction.

Referring mainly to FIG. 2, the workpiece conveyance section 20 includes a feed roller 21 for delivering the workpiece W before printing and a take-up roller 22 for winding the workpiece W after printing. The feed roller 21 is arranged in the rearward lower portion of the apparatus frame 10 and is a winding shaft of a feed roll WA, which is a winding body of the workpiece W before printing. The take-up roller 22 is arranged in the front lower portion of the apparatus frame 10 and is a winding shaft of a take-up roll WB, which is the winding body of the workpiece W after the printing process. The take-up roller 22 is attached with a first motor M1 that rotates and drives the take-up roller 22 around the axis to execute the winding operation of the workpiece W.

A path, which is located between the feed roller 21 and the take-up roller 22 and passes through the printing area 12, is the conveyance path of the workpiece W. In this conveyance path, a first tension roller 23, a workpiece guide 24, a conveyance roller 25, a pinch roller 26, a return roller 27, and a second tension roller 28 are arranged in order from the upstream side. The first tension roller 23 applies a predetermined tension to the workpiece W upstream of the conveyance roller 25. The workpiece guide 24 changes the conveyance direction of the workpiece W from the upward direction to the forward direction and conveys the workpiece W into the printing area 12.

The conveyance roller 25 is a roller that generates a conveyance force to intermittently feed the workpiece W in the printing area 12. The conveyance roller 25 is driven to rotate around the axis by a second motor M2 and intermittently conveys the workpiece W in the forward direction (predetermined conveyance direction F) so that the workpiece W passes through the printing area 12 (image forming position) facing the carriage 3. The pinch roller 26 is arranged so as to face the conveyance roller 25 from above, and forms a conveyance nip with the conveyance roller 25.

The return roller 27 changes the conveyance direction of the workpiece W, which has passed through the printing area 12, from the forward direction to the downward direction, and guides the workpiece W after the printing process to the take-up roller 22. The second tension roller 28 applies a predetermined tension to the workpiece W downstream of the conveyance roller 25. A platen 29 is arranged below the conveyance path of the workpiece W in the printing area 12.

The carriage 3 reciprocates in the main scanning direction S (left-right direction in the present embodiment) that intersects (orthogonal in the present embodiment) the conveyance direction F while being cantilevered by the guide rail 17. The carriage 3 includes a carriage frame 30 and the ink head 4, pre-treatment liquid head 5, post-treatment liquid head 6 and sub-tank 7 (FIG. 3) mounted on the carriage frame 30. The carriage frame 30 includes a head support frame 31 and a back frame 32.

The head support frame 31 is a horizontal plate for holding the heads 4 to 6 described above. The back frame 32 is a vertical plate extending upward from the rear end edge of the head support frame 31. As described above, the timing belt 16 is fixed to the back frame 32. The guide rails 17 are engaged with the back frame 32. That is, in the present embodiment, the back frame 32 is an engaging section held cantilevered by the guide rails 17. The head support frame 31 is a horizontal plate whose rear end side is cantilevered by the engaging section to the guide rails 17.

The cantilevered state represents a state in which the engaging section (back frame 32), which is a section held by the guide rails 17 as holding members in the carriage 3, exists only on one side, upstream or downstream of the center of carriage 3 in the conveyance direction F, and no other engaging section exists on the opposite side to the side where the engaging section exists. Further, the engaging section may be located outside the range where the ink head 4 and the treatment heads are located in the conveyance direction F. That is, the engaging section may be located only upstream or downstream of the range where the ink head 4 and the treatment heads are located in the conveyance direction F.

### Details of Carriage

Further description will be given regarding the carriage 3. FIG. 3 is an enlarged perspective view of the carriage 3 illustrated in FIG. 1. FIG. 3 illustrates the conveyance direction F (sub scanning direction) of the workpiece W, and the main scanning direction S that is a movement direction of the carriage 3. FIG. 3 illustrates an example in which a plurality of ink heads 4 for ejecting ink for image formation onto the workpiece W, pre-treatment liquid heads 5 and post-treatment liquid heads 6 for ejecting non-chromatic treatment liquid, and a plurality of sub-tanks 7 for supplying the ink and treatment liquid to these heads 4 to 6 are mounted on the carriage 3.

Each of the ink heads 4 includes a number of nozzles (ink discharge holes) for ejecting ink droplets by an ejecting method such as, for example, a piezo method using a piezo element or a thermal method using a heating element, and ink paths for guiding ink to the nozzles. As the ink, for example, water-based pigment ink containing water-based solvent, pigment, and binder resin can be used. The plurality of ink heads 4 in the present embodiment can eject ink of eight colors. The ink heads 4 are mounted on the head support frame 31 of the carriage 3 in two rows in the main scanning direction S. The ink heads 4 of each color include 2 heads.

Specifically, the ink heads 4 include a first upstream ink head 41A and a first downstream ink head 41B. These ink heads 4 eject yellow ink. The ink heads 4 include a second upstream ink head 42A and a second downstream ink head 42B. These ink heads 4 eject magenta ink. Similarly, as illustrated in FIG. 3, two ink heads 4 for ejecting ink of the same color are arranged at mutually different positions in the conveyance direction F and the main scanning direction S. As a set of these two ink heads 4, a total of 8 sets of ink heads 4 (41A to 48A, 41B to 48B) eject ink of different colors from each other.

The pre-treatment liquid heads 5 and the post-treatment liquid heads 6 are located in different positions from the ink heads 4 in the conveyance direction F. The pre-treatment liquid heads 5 are located upstream of the ink heads 4 in the conveyance direction F. FIG. 3 illustrates an example where one pre-treatment liquid head 5 is located near the left end of the ink head 4 array. Similarly, the post-treatment liquid heads 6 are located downstream of the ink heads 4 in the conveyance direction F. FIG. 3 illustrates an example where one post-treatment liquid head 6 is located at the right end of the ink head 4 array. In other embodiments, a plurality of pre-treatment liquid heads 5 or a plurality of post-treatment liquid heads 6 may be located. Preferably, the carriage 3 includes at least one pre-treatment liquid head 5 and at least one post-treatment liquid head 6, individually, but in other embodiments, the pre-treatment liquid head 5 and post-treatment liquid head 6 need not be located.

A series of heads along the main scanning direction S composed of the ink heads 4, pre-treatment liquid heads 5 and post-treatment liquid heads 6 is referred to as a column of heads or simply a column. A series of heads along the conveyance direction F composed of the ink heads 4, pre-treatment liquid heads 5 and post-treatment liquid heads 6 is referred to as a row of heads or simply a row.

The pre-treatment liquid head 5 ejects a pre-treatment liquid for applying a predetermined pre-treatment onto the workpiece W. The pre-treatment liquid head 5 ejects the pre-treatment liquid from the ink head 4 onto a position of the workpiece W, to which the ink has not yet been ejected from the ink head 4. The pre-treatment liquid is a non-chromatic treatment liquid that does not develop color even when adhering to the workpiece W, and is, for example, a treatment liquid that exhibits a function of enhancing the fixability of ink to the workpiece W and the cohesiveness of the ink pigment. As such a pre-treatment liquid, a treatment liquid containing a binder resin in the solvent or a treatment liquid containing a cationic resin that positively charges the solvent, can be used.

The post-treatment liquid head 6 ejects a post-treatment liquid for applying a predetermined post-treatment onto the workpiece W to which the ink has adhered. The post-treatment liquid head 6 ejects the post-treatment liquid onto a position of the workpiece W, to which the ink has been ejected from the ink head 4. The post-treatment liquid is a non-chromatic treatment liquid that does not develop color even when adhering to the workpiece W in the same way, and is a treatment liquid that exhibits a function of enhancing the fixability and robustness (resistance to rubbing and scraping) of the ink image printed on the workpiece W by the ink head 4. As such a post-treatment liquid, a silicone-based treatment liquid or the like can be used. The post-treatment liquid and the pre-treatment liquid are different treatment liquids. Specifically, the post-treatment liquid and the pre-treatment liquid contain different components.

Here, the non-chromatic treatment liquid refers to a liquid that is not recognized by the naked eye as having a color when printed alone on a recording medium. Here, color includes one having zero saturation such as black, white, or gray. The non-chromatic treatment liquid is basically a transparent liquid. However, for example, when one liter of the treatment liquid is viewed as a liquid, it may not be completely transparent and may appear slightly white. Such a color is extremely light and cannot be recognized by the naked eye as a color when printed alone on a recording medium. Depending on the type of treatment liquid, when printed on a recording medium by itself, there may be changes such as the creation of gloss on the recording medium, but such a state is not considered to be a color.

In the present embodiment, the pre-treatment liquid and post-treatment liquid may be ejected almost over the entire surface of the workpiece W, or may be ejected selectively according to the image to be printed in the same manner as ink.

The case of selectively ejecting the pre-treatment liquid and the post-treatment liquid will be described. As described above, the pre-treatment liquid, the ink, and the post-treatment liquid are ejected in order, onto the workpiece W in the portion where colors are printed according to the image. In this case, the ink may be of one color or a plurality of colors. Basically, the pre-treatment liquid and the post-treatment liquid are not ejected onto the portion where colors are not printed, that is, the ink is not ejected. In order to adjust the image quality of the image to be printed and the texture of the workpiece W, the selection of the ejection of the pre-treatment liquid and the post-treatment liquid may be partially different from that of the ejection of the ink.

As illustrated in FIG. 3, an opening 31H is provided at the placement position of the head of the head support frame 31. The ink heads 4, the pre-treatment liquid heads 5, and the post-treatment liquid heads 6 are assembled in the head support frame 31 so as to be fitted into each opening 31H. Each of the nozzles arranged on the lower end surfaces of the heads 4, 5, and 6 are exposed from each opening 31H.

The plurality of sub-tanks 7 are supported by the carriage 3 on the upper side of the heads 4, 5 and 6 via the holding frame not illustrated. The plurality of sub-tanks 7 are each provided corresponding to each of the heads 4, 5 and 6. Each sub-tank 7 is supplied with ink or treatment liquid from a main tank 90 containing ink or treatment liquid, which are supplied to each of the heads 4, 5 and 6. Each sub-tank 7 is connected to the corresponding one of the heads 4, 5 and 6 by a pipe not illustrated in FIG. 3.

Specifically, the plurality of sub-tanks 7 include a first supply sub-tank 71A to an eighth supply sub-tank 78A, a pre-treatment supply sub-tank 7FA, and a post-treatment supply sub-tank 7RA arranged along the main scanning direction S on the rear side. The plurality of sub-tanks 7 include a first recovery sub-tank 71B to an eighth recovery sub-tank 78B, a pre-treatment recovery sub-tank 7FB, and post-treatment recovery sub-tank 7RB arranged along the main scanning direction S on the front side.

The first supply sub-tank 71A and the first recovery sub-tank 71B located on the leftmost side of the carriage 3 contain yellow ink. The first supply sub-tank 71A supplies yellow ink to the first upstream ink head 41A and the first downstream ink head 41B. On the other hand, the first recovery sub-tank 71B recovers the yellow ink from the first upstream ink head 41A and the first downstream ink head 41B. At this time, some yellow ink is ejected from the first upstream ink head 41A and the first downstream ink head 41B toward the workpiece W. Similarly, a second supply sub-tank 72A supplies magenta ink to the second upstream ink head 42A and second downstream ink head 42B. On the other hand, a second recovery sub-tank 72B recovers magenta ink from the second upstream ink head 42A and second downstream ink head 42B. Other sub-tanks from the third sub-tank to eighth sub-tank have the same structure and function as described above.

The pre-treatment supply sub-tank 7FA supplies the pre-treatment liquid to the pre-treatment liquid head 5, and the pre-treatment recovery sub-tank 7FB recovers pre-treatment liquid from the pre-treatment liquid head 5. The post-treatment supply sub-tank 7RA supplies the post-treatment liquid to the post-treatment liquid head 6, and the post-treatment recovery sub-tank 7RB recovers post-treatment liquid from the post-treatment liquid head 6.

As described above, the ink jet printer 1 according to the present embodiment is an all-in-one printer in which three types of heads: the ink head 4; the pre-treatment liquid head 5; and the post-treatment liquid head 6, are mounted in one carriage 3. According to the ink jet printer 1, for example, in the printing process of inkjet printing on a fabric in digital textile printing, the pre-treatment liquid ejection step and post-treatment liquid ejection step can be integrally executed. Thus, the textile printing process can be simplified and the textile printing apparatus can be made compact.

Note that the ink jet printer 1 according to the present embodiment performs printing processing on the workpiece W by the serial printing method. Specifically, when the workpiece W has a wide size, printing cannot be performed while continuously feeding the workpiece W. The serial printing method is a printing method that repeats reciprocating movement of the carriage 3, on which the ink heads 4 of respective colors are mounted, in the main scanning direction S, and intermittent feeding of the workpiece W in the conveyance direction F.

Specifically, while the carriage 3 moves in the forward direction, which is one of the main scanning directions S, printing of the strip shape image is performed. During the main scanning in the forward direction, feeding of the workpiece W is stopped. After printing the strip shape image, the workpiece W is sent out in the conveyance direction F by a predetermined pitch. At this time, the carriage 3 waits at the return area 14 on the left end side. After sending out the workpiece W, the carriage 3 turns back in the backward direction opposite the forward direction with the reverse movement of the timing belt 16. The workpiece W is in a stop state. Then, while moving in the backward direction, the carriage 3 prints a next strip shape image upstream of the strip shape image. Hereinafter, the same operation is repeated.

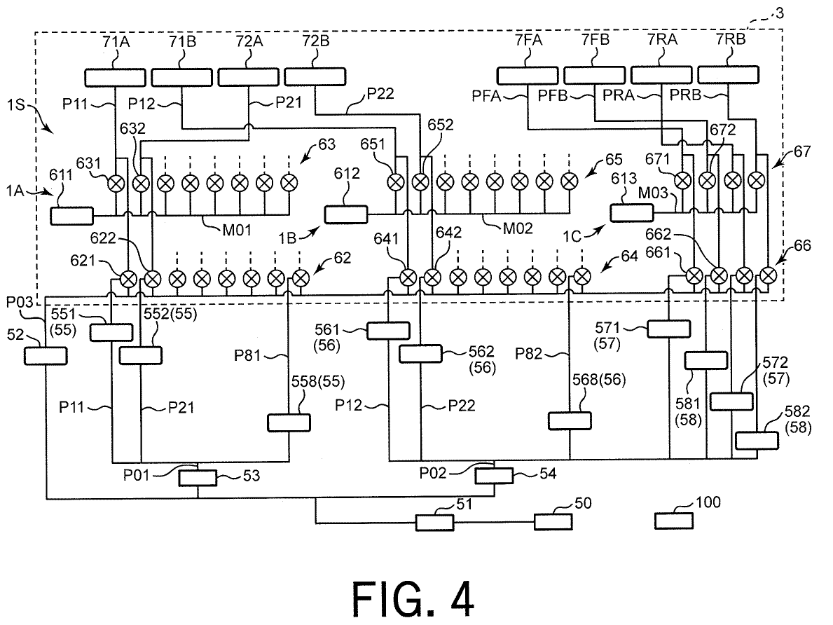

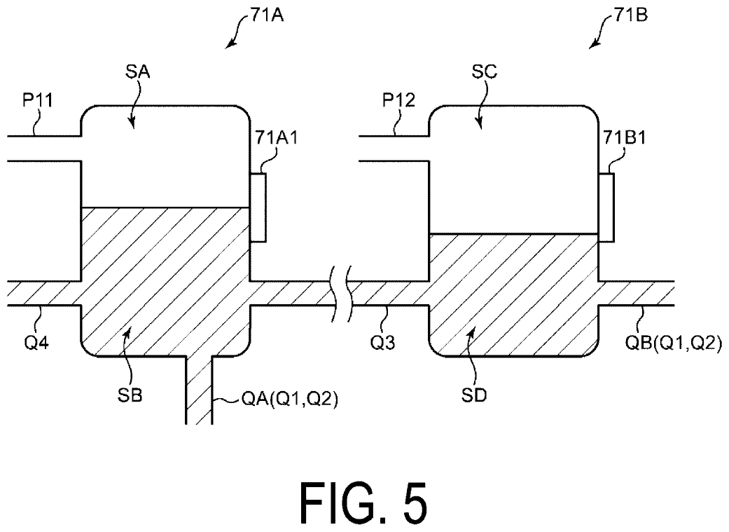

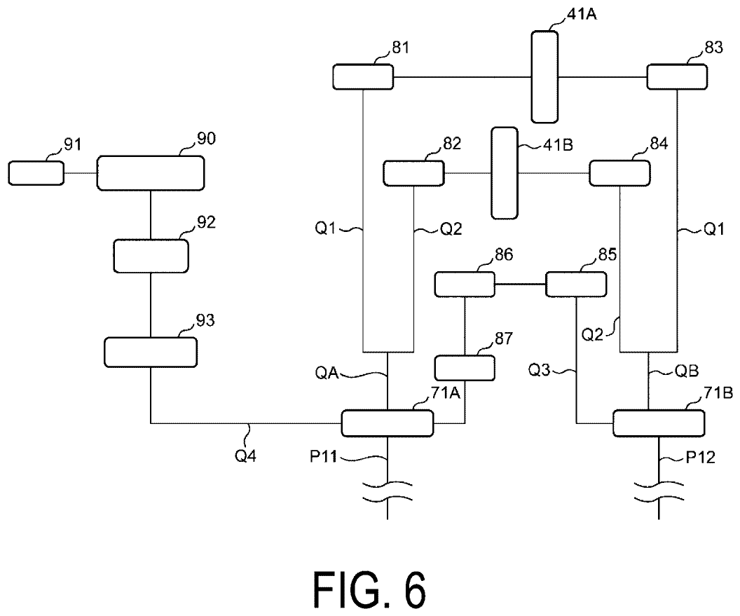

Supply of pressure and ink to each ink head 4 according to the present embodiment will be described with reference to FIGS. 4 to 6. FIG. 4 is a schematic diagram illustrating a plurality of pressure transmission paths around the carriage 3 according to the present embodiment. FIG. 5 is a schematic diagram illustrating the supply sub-tank and the recovery sub-tank according to the present embodiment. FIG. 6 is a schematic diagram illustrating a flow of ink around the liquid ejection head according to the present embodiment. In each of the drawings, a line connecting the members indicates a pipe (tube) through which a gas or a liquid flows.

In the present embodiment, pressure is applied through a gas (air) to each of the first supply sub-tank 71A to the post-treatment supply sub-tank 7RA, the first recovery sub-tank 71B to the post-treatment recovery sub-tank 7RB mounted on the carriage 3 in FIG. 3. As a result, a liquid (ink, pre-treatment liquid and post-treatment liquid) is supplied from each of the supply sub-tanks to the ink head 4, the pre-treatment liquid head 5, and the post-treatment liquid head 6, respectively. First, the pressure supply route to each sub-tank 7 will be described with reference to FIG. 4.

The ink jet printer 1 includes: a controller 100; a compressor 50 (gas pressure source); a filter 51; a purge main regulator 52; a first main regulator 53; a second main regulator 54; an ink supply regulator 55; an ink recovery regulator 56; a treatment liquid supply regulator 57; and a treatment liquid recovery regulator 58. These devices or members are located outside the carriage 3 in the apparatus frame 10 (FIG. 1) of the ink jet printer 1.

The controller 100 controls the operation of the ink jet printer 1 and electrically controls each member illustrated in FIG. 4.

The compressor 50 generates the pressure supplied to each sub-tank 7 and compresses the gas and continuously sends it out. As the compressor 50, known reciprocating compressors and rotary compressors can be used. As an example, the compressor pressure is set to 500 to 800 kPa.

The filter 51 removes foreign matter, dust, or the like, contained in the gas discharged from the compressor 50. As an example, the opening diameter of the filter 51 is set to 5 μm. The gas passed through the filter 51 flows into three flow paths: a first main pressure supply path P01; a second main pressure supply path P02; and a purge pressure supply path P03.

The purge main regulator 52 is located downstream of the filter 51 in the gas flow and is used to adjust the pressure of the purge pressure supply path P03. Similarly, the first main regulator 53 is located downstream of the filter 51 in the gas flow and is used to adjust the pressure of the first main pressure supply path P01. Similarly, the second main regulator 54 is located downstream of the filter 51 in the gas flow and is used to adjust the pressure of the second main pressure supply path P02. The purge main regulator 52, the first main regulator 53, and the second main regulator 54 are, for example, NPN type regulators with open collector outputs. These regulators each receive a command signal from the controller 100 and open valves to adjust the pressure of each flow path to match the signal.

As illustrated in FIG. 4, the first main pressure supply path P01 is divided into eight flow paths corresponding to the first supply sub-tank 71A to the eighth supply sub-tank 78A downstream of the first main regulator 53. Of these eight flow paths, FIG. 4 illustrates a first supply side pressure supply path P11, a second supply side pressure supply path P21, and an eighth supply side pressure supply path P81, and does not illustrate the other flow paths. The first supply side pressure supply path P11 is a flow path extending from the first main pressure supply path P01 (first main regulator 53) to the first supply sub-tank 71A. Similarly, the second supply side pressure supply path P21 is a flow path extending from the first main pressure supply path P01 to the second supply sub-tank 72A. The eighth supply side pressure supply path P81 is a flow path extending from the first main pressure supply path P01 to the eighth supply sub-tank 78A (FIG. 3).

The ink supply regulator 55 is arranged in each supply side pressure supply path and has a function of adjusting the pressure supplied to the supply sub-tank for each ink. As an example, the ink supply regulator 55 is composed of an electro-pneumatic regulator. In FIG. 4, a first ink supply regulator 551, a second ink supply regulator 552, and an eighth ink supply regulator 558 are illustrated corresponding to the first supply side pressure supply path P11, the second supply side pressure supply path P21, and the eighth supply side pressure supply path P81, and other ink supply regulators are not illustrated. These regulators each receive a command signal from the controller 100 and open valves to adjust the pressure of each flow path to match the signal. As an example, the target pressure applied by each ink supply regulator 55 to the supply sub-tank is set to 15 kPa.

On the other hand, the second main pressure supply path P02, downstream of second main regulator 54, is divided into 12 flow paths corresponding to: the first recovery sub-tank 71B to the eighth recovery sub-tank 78B, and further; the pre-treatment supply sub-tank 7FA; the pre-treatment recovery sub-tank 7FB; the post-treatment supply sub-tank 7RA; and the post-treatment recovery sub-tank 7RB. FIG. 4, illustrates, among these 12 flow paths, a first recovery side pressure supply path P12; a second recovery side pressure supply path P22; an eighth recovery side pressure supply path P82; a pre-treatment liquid pressure supply path PFA; a pre-treatment liquid pressure recovery path PFB; a post-treatment liquid pressure supply path PRA; and a post-treatment liquid pressure recovery path PRB, and other flow paths are omitted. The first recovery side pressure supply path P12 is a flow path that extends from the second main pressure supply path P02 (second main regulator 54) to the first recovery sub-tank 71B. Similarly, the second recovery side pressure supply path P22 is a flow path that extends from the second main pressure supply path P02 to the second recovery sub-tank 72B. The eighth recovery side pressure supply path P82 is a flow path that extends from the second main pressure supply path P02 to the eighth recovery sub-tank 78B. The pre-treatment liquid pressure supply path PFA is a flow path that extends from the second main pressure supply path P02 (second main regulator 54) to the pre-treatment supply sub-tank 7FA. The pre-treatment liquid pressure recovery path PFB is a flow path that extends from the second main pressure supply path P02 to the pre-treatment recovery sub-tank 7FB. The post-treatment liquid pressure supply path PRA is a flow path that extends from the second main pressure supply path P02 to the post-treatment supply sub-tank 7RA. The post-treatment liquid pressure recovery path PRB is a flow path that extends from the second main pressure supply path P02 to the post-treatment recovery sub-tank 7RB.

The ink recovery regulator 56 is arranged in each recovery side pressure supply path and has a function of adjusting the pressure supplied to each ink recovery sub-tank. As an example, the ink recovery regulator 56 is composed of an electro-pneumatic regulator. FIG. 4 illustrates: a first ink recovery regulator 561; a second ink recovery regulator 562; and an eighth ink recovery regulator 568 corresponding to: the first recovery side pressure supply path P12; the second recovery side pressure supply path P22; and the eighth recovery side pressure supply path P82, and illustration of other ink recovery regulators are omitted. These regulators each receive a command signal from the controller 100 and open valves to adjust the pressure of each flow path to match the signal. As an example, the target pressure applied by each ink recovery regulator 56 to each ink recovery sub-tank is set to −20 kPa.

Similarly, the treatment liquid supply regulator 57 (pre-treatment liquid supply regulator 571, post-treatment liquid supply regulator 572) is arranged in the supply side pressure supply path of each treatment liquid. The treatment liquid recovery regulator 58 (pre-treatment liquid recovery regulator 581, post-treatment liquid recovery regulator 582) is arranged in the recovery side pressure supply path of each treatment liquid. These regulators have the same structure and function as the ink supply regulators 55 and the ink recovery regulators 56. As an example, the target pressure applied by the treatment liquid supply regulator 57 and the treatment liquid recovery regulator 58 to each treatment liquid sub-tank is set to −5 kPa.

Among the above pressure transmission paths, the path on the carriage 3 will be described. As illustrated in FIG. 4, the ink jet printer 1 further includes: a first pressure measurement section 1A; a second pressure measurement section 1B; a third pressure measurement section 1C; an ink supply purge valve 62; an ink supply measurement valve 63; an ink recovery purge valve 64; an ink recovery measurement valve 65; a treatment liquid purge valve 66; and a treatment liquid measurement valve 67, which are disposed on the carriage 3.

The first pressure measurement section 1A includes a first pressure sensor 611 and a first pressure measurement path M01. The second pressure measurement section 1B includes a second pressure sensor 612 and a second pressure measurement path M02. The third pressure measurement section 1C includes a third pressure sensor 613 and a third pressure measurement path M03.

The first pressure sensor 611 measures the pressure of the first pressure measurement path M01, and inputs a signal corresponding to the measurement result to the controller 100. Similarly, the second pressure sensor 612 measures the pressure of the second pressure measurement path M02, and inputs a signal corresponding to the measurement result to the controller 100. The third pressure sensor 613 measures the pressure of the third pressure measurement path M03, and inputs a signal corresponding to the measurement result to the controller 100. The first pressure measurement path M01 can communicate with any of the supply paths from the first supply side pressure supply path P11 to the eighth supply side pressure supply path P81 according to the opening and closing of the ink supply measurement valve 63. Similarly, the second pressure measurement path M02 can communicate with any of the supply paths from the first recovery side pressure supply path P12 to the eighth recovery side pressure supply path P82 according to the opening and closing of the ink recovery measurement valve 65. The third pressure measurement path M03 can communicate with any of the supply paths from the pre-treatment liquid pressure supply path PFA, the pre-treatment liquid pressure recovery path PFB, the post-treatment liquid pressure supply path PRA, and the post-treatment liquid pressure recovery path PRB according to the opening and closing of the treatment liquid measurement valve 67.

The ink supply purge valve 62 includes eight valves for connecting the purge pressure supply path P03 to any one of the first supply side pressure supply path P11 to the eighth supply side pressure supply path P81. As illustrated in FIG. 4, the ink supply purge valve 62 includes: a first ink supply purge valve 621 located in the first supply side pressure supply path P11; and a second ink supply purge valve 622 located at the second supply side pressure supply path P21. Each of these valves is composed of a known three-port solenoid valve. In the present embodiment, along with the ink recovery purge valve 64 and the treatment liquid purge valve 66, a total of 20 three-port solenoid valves are arranged in a single valve section as a 20-unit three-port solenoid valve assembly.

The ink supply measurement valve 63 includes eight valves for connecting the first pressure measurement path M01 to one of the first supply side pressure supply path P11 to the eighth supply side pressure supply path P81, as described above. As illustrated in FIG. 4, the ink supply measurement valve 63 includes a first ink supply measurement valve 631 connected to the first supply side pressure supply path P11 and a second ink supply measurement valve 632 connected to the second supply side pressure supply path P21. Each of these valves is composed of a known two-port solenoid valve. In the present embodiment, eight two-port solenoid valves are arranged in a single valve section as an 8-unit two-port solenoid valve assembly.

An ink recovery purge valve 64 is composed of eight valves for connecting the purge pressure supply path P03 to any one of the first recovery side pressure supply path P12 to the eighth recovery side pressure supply path P82. As illustrated in FIG. 4, the ink recovery purge valve 64 includes a first ink recovery purge valve 641 located at the first recovery side pressure supply path P12 and a second ink recovery purge valve 642 located at the second recovery side pressure supply path P22. Each of these valves is composed of a known three-port solenoid valve. A vacuum ejector (not illustrated) is disposed between the first ink recovery purge valve 641 and the first ink recovery regulator 561. The same applies between each of the other recovery valves and the recovery regulators.

As described above, the ink recovery measurement valve 65 is composed of 8 valves for connecting the second pressure measurement path M02 to one of the first recovery side pressure supply path P12 to the eighth recovery side pressure supply path P82. As illustrated in FIG. 4, the ink recovery measurement valve 65 includes a first ink recovery measurement valve 651 connected to the first recovery side pressure supply path P12 and a second ink recovery measurement valve 652 connected to the second recovery side pressure supply path P22. Each of these valves is composed of a known two-port solenoid valve. In the present embodiment, eight two-port solenoid valves are arranged in a single valve section as an 8-unit two-port solenoid valve assembly.

The treatment liquid purge valve 66 is composed of four valves for connecting the purge pressure supply path P03 to one of the pre-treatment liquid pressure supply path PFA, the pre-treatment liquid pressure recovery path PFB, the post-treatment liquid pressure supply path PRA, and the post-treatment liquid pressure recovery path PRB. As illustrated in FIG. 4, the treatment liquid purge valve 66 includes a first treatment liquid purge valve 661 connected to the pre-treatment liquid pressure supply path PFA and a second treatment liquid purge valve 662 connected to the pre-treatment liquid pressure recovery path PFB. As described above, each of these valves is a known three-port solenoid valve.

The treatment liquid measurement valve 67 is composed of four valves for connecting the third pressure measurement path M03 to one of the pre-treatment liquid pressure supply path PFA, the pre-treatment liquid pressure recovery path PFB, the post-treatment liquid pressure supply path PRA, and the post-treatment liquid pressure recovery path PRB. As illustrated in FIG. 4, the treatment liquid measurement valve 67 includes a first treatment liquid measurement valve 671 connected to the pre-treatment liquid pressure supply path PFA, and a second treatment liquid measurement valve 672 connected to the pre-treatment liquid pressure recovery path PFB. Each of these valves is composed of a known two-port solenoid valve. In the present embodiment, four two-port solenoid valves are arranged in a single valve section as a 4-unit two-port solenoid valve assembly.

The structure of the sub-tank 7 will be further described with reference to FIG. 5. In the following description, the first supply sub-tank 71A and the first recovery sub-tank 71B, which supply and recover yellow ink, will be described as examples, but the same applies to other sub-tank 7 structures.

The first supply sub-tank 71A has a box-like structure, and when storing yellow ink, forms a supply tank gas region SA and a supply tank ink region SB. The supply tank gas region SA is a space above the liquid level of the yellow ink in the first supply sub-tank 71A, and the supply tank ink region SB is a region formed by the yellow ink. The supply tank gas region SA communicates with the first supply side pressure supply path P11 described above. The supply tank ink region SB communicates with each of an ink supply path QA (first ink path Q1, second ink path Q2), an ink circulation path Q3, and an ink replenishment path Q4, which are described below.

The first supply sub-tank 71A includes a capacitance sensor 71A1 that can detect the liquid level (ink amount) of the yellow ink in the first supply sub-tank 71A.

Similarly, the first recovery sub-tank 71B has a box-like structure, and when storing yellow ink, forms a recovery tank gas region SC and a recovery tank ink region SD. The recovery tank gas region SC is a space above the liquid level of the yellow ink in the first recovery sub-tank 71B, and the recovery tank ink region SD is a region formed by the yellow ink. The recovery tank gas region SC communicates with the first recovery side pressure supply path P12 described above. The recovery tank ink region SD communicates with each of an ink recovery path QB (first ink path Q1, second ink path Q2) and the ink circulation path Q3.

The first recovery sub-tank 71B includes a capacitance sensor 71B1 that can detect the liquid level (ink amount) of the yellow ink in the first recovery sub-tank 71B.

The supply and recovery path of the yellow ink to the first upstream ink head 41A and the first downstream ink head 41B will be described with reference to FIG. 6. The same structure as that illustrated in FIG. 6 is also provided for ink heads of other colors. The ink jet printer 1 further includes filters 81, 82, 83 and 84 that are arranged on the carriage 3, a circulation pump 85, a check valve 86, and a degasser 87. The ink jet printer 1 further includes the main tank 90, a capacitance sensor 91, a main tank valve 92 and a main supply pump 93, which are arranged on the apparatus frame 10 (FIG. 1) outside the carriage 3.

The yellow ink flowing into the ink supply path QA from the first supply sub-tank 71A flows into a first ink path Q1 via the first upstream ink head 41A and a second ink path Q2 via the first downstream ink head 41B. A filter 81 is arranged upstream of the first upstream ink head 41A and a filter 82 is arranged upstream of the first downstream ink head 41B. A filter 83 is located downstream of the first upstream ink head 41A, and a filter 84 is located downstream of the first downstream ink head 41B. These filters have a function of removing foreign matter, dust, or the like from the ink. After a part of the yellow ink is ejected from the first upstream ink head 41A and the first downstream ink head 41B onto the workpiece W, the other ink is recovered from the ink recovery path QB to the first recovery sub-tank 71B.

On the other hand, when the controller 100 determines from the output of the capacity sensor 71A1 (FIG. 5) that the ink in the first supply sub-tank 71A is low, the circulation pump 85 is activated in response to the command signal input from the controller 100. As a result, a part of the yellow ink in the first recovery sub-tank 71B is supplied to the first supply sub-tank 71A through the ink circulation path Q3. The check valve 86 helps prevent the backflow of ink from the first supply sub-tank 71A to the first recovery sub-tank 71B in the ink circulation path Q3. The degasser 87 also removes air bubbles in the ink flowing into the first supply sub-tank 71A.

When the controller 100 determines that the amount of yellow ink in the sub-tanks of both the first supply sub-tank 71A and the first recovery sub-tank 71B has fallen below the preset threshold value based on the detection results of the capacity sensors 71A1 and 71B1, the controller 100 activates the main supply pump 93 to replenish the yellow ink from the main tank 90 to the first supply sub-tank 71A through the ink replenishment path Q4. The main tank valve 92 is opened so as to adjust the maximum supply amount (supply speed) for the first supply sub-tank 71A. When the capacitance sensor 91 detects that the remaining amount of yellow ink in the main tank 90 is low, the controller 100 causes a display (not illustrated) of the ink jet printer 1 to display an ink replenishment message.

### Pressure Transmission Path During Printing

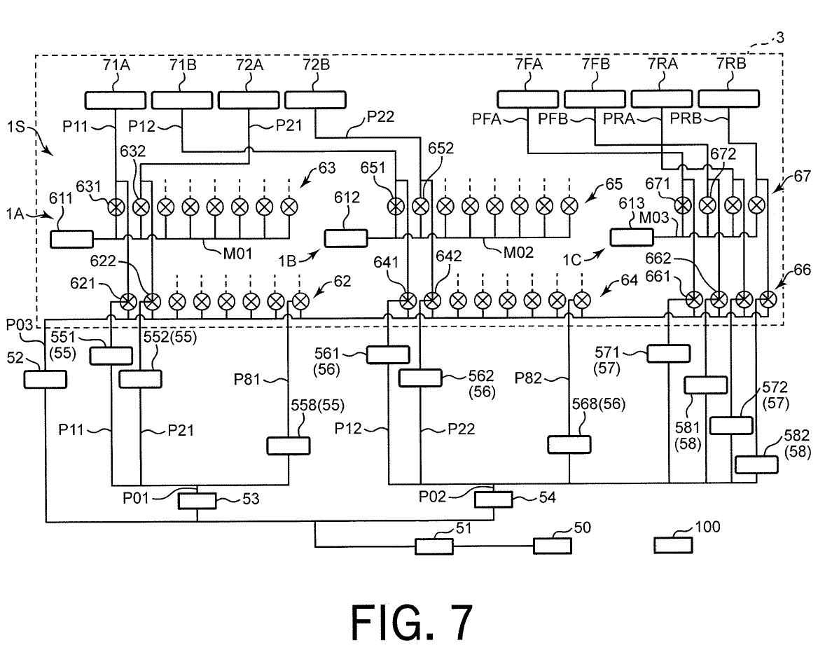

FIG. 7 is a schematic diagram illustrating the state during printing (liquid ejection) corresponding to FIG. 4. In FIG. 7, the sub-tank 7 (first supply sub-tank 71A, first recovery sub-tank 71B) corresponding to the yellow ink and the sub-tank 7 (second supply sub-tank 72A, second recovery sub-tank 72B) corresponding to magenta ink, will be described below. The same applies to other colors.

When the ink jet printer 1 ejects ink onto the workpiece W and performs printing, the first ink supply purge valve 621 communicates with the first ink supply regulator 551 and the first supply sub-tank 71A, and the second ink supply purge valve 622 communicates with the second ink supply regulator 552 and the second supply sub-tank 72A, as illustrated in FIG. 7. Also, the first ink recovery purge valve 641 communicates with the first ink recovery regulator 561 and the first recovery sub-tank 71B, and the second ink recovery purge valve 642 communicates with the second ink recovery regulator 562 and second recovery sub-tank 72B. In other words, the first supply side pressure supply path P11, the first recovery side pressure supply path P12, the second supply side pressure supply path P21, and second recovery side pressure supply path P22 are blocked against the purge pressure supply path P03.

As a result, the adjustment pressure of the first ink supply regulator 551 is applied to the yellow ink of the supply tank ink region SB via the supply tank gas region SA of the first supply sub-tank 71A. Similarly, the adjustment pressure of the first ink recovery regulator 561 is applied to the yellow ink of the recovery tank ink region SD via the recovery tank gas region SC of the first recovery sub-tank 71B. Thus, as illustrated in FIGS. 5 and 6, since the ink inside each of the first upstream ink head 41A and the first downstream ink head 41B is adjusted to a predetermined pressure via the ink supply path QA and the ink recovery path QB, the likelihood of unintentional ink ejection from the ink head nozzle is reduced.

In the present embodiment, during printing operation, the controller 100 sequentially opens each of the ink supply measurement valve 63 and the ink recovery measurement valve 65. Specifically, as illustrated in FIG. 7, the first ink supply measurement valve 631 communicates with the first supply side pressure supply path P11 and the first pressure measurement path M01, while the other valves of the ink supply measurement valves 63 including the second ink supply measurement valve 632 are closed. In this state, the first pressure sensor 611 may measure the pressure of the first pressure measurement path M01, thereby enabling measurement of the pressure applied to the supply tank ink region SB through the supply tank gas region SA of the first supply sub-tank 71A. Similarly, the first ink recovery measurement valve 651 communicates with the first recovery side pressure supply path P12 and the second pressure measurement path M02, while the other valves of the ink recovery measurement valves 65 including the second ink recovery measurement valve 652 are closed. In this state, the second pressure sensor 612 may measure the pressure of the second pressure measurement path M02, thereby enabling measurement of the pressure applied to the recovery tank ink region SD through the recovery tank gas region SC of the first recovery sub-tank 71B.

The controller 100 controls the valves by closing the first ink supply measurement valve 631, opening the second ink supply measurement valve 632, and closing the first ink recovery measurement valve 651, and opening the second ink recovery measurement valve 652. In this state, the first pressure sensor 611 may measure the pressure of the first pressure measurement path M01, thereby enabling measurement of the pressure applied to the supply tank ink region SB through the supply tank gas region SA of the second supply sub-tank 72A. The second pressure sensor 612 may measure the pressure of the second pressure measurement path M02, thereby enabling measurement of the pressure applied to the recovery tank ink region SD through the recovery tank gas region SC of the second recovery sub-tank 72B. Thereafter, the pressure applied to the ink in the supply sub-tank and the recovery sub-tank of each color in order can be measured.

The controller 100 adjusts the pressure applied to each sub-tank by adjusting the opening of each ink supply regulator 55 and each ink recovery regulator 56 based on the PID control from the pressure measured as described above, which can consequently adjust the pressure applied to the ink in the ink head 4. The same applies to the pressure measurement and pressure adjustment of each treatment liquid sub-tank and each treatment liquid head using the third pressure sensor 613 and the treatment liquid measurement valve 67.

### Pressure Transmission Path During Purge Operation

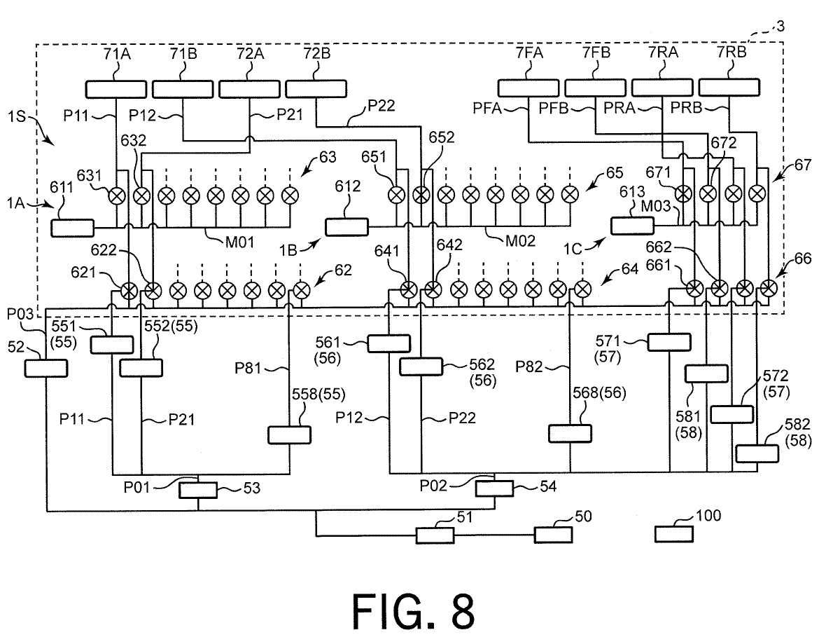

FIG. 8 is a schematic diagram illustrating the purge operation corresponding to FIG. 4. The purge operation is an operation where, in order to release or help prevent ink clogging in the ink head 4, a higher pressure is applied to the ink head 4 than at the time of printing, and ink is ejected from the nozzle of the ink head 4. Referring to FIG. 8, when the purge pressure is applied to the first upstream ink head 41A and the first downstream ink head 41B, the controller 100 opens the first ink supply purge valve 621 of the ink supply purge valve 62 and communicates with the first supply side pressure supply path P11 and the purge pressure supply path P03, whereby the purge pressure adjusted by the purge main regulator 52 acts on the first supply side pressure supply path P11. At this time, the first ink supply measurement valve 631 is closed in order to reduce the likelihood of damage to the first pressure sensor 611 due to application of the purge pressure to the first pressure sensor 611.

On the other hand, in the first recovery side pressure supply path P12 communicating with the first recovery sub-tank 71B, the first ink recovery measurement valve 651 is similarly closed in order to reduce the likelihood of applying the purge pressure to the second pressure sensor 612. The first ink recovery purge valve 641 communicates the first recovery side pressure supply path P12 and the first ink recovery regulator 561.

At this time, a two-port solenoid valve (not illustrated) may be disposed upstream of the first recovery sub-tank 71B (between the first recovery sub-tank 71B and first ink recovery measurement valve 651 in FIG. 8), and the two-port solenoid valve may be closed when the purge pressure is applied to each ink head through the first supply side pressure supply path P11. The above-described two-port solenoid valve may be disposed downstream of the first recovery sub-tank 71B (ink recovery path QB in FIG. 6), and the same switching may be performed. As a result, purge pressure can be applied from the supply side to each ink head while the path on the recovery side is closed.

As another embodiment, the first ink recovery purge valve 641 may be opened so that the first recovery side pressure supply path P12 and the purge pressure supply path P03 communicate with each other. In this case, since the purge pressure also acts on the first upstream ink head 41A and the first downstream ink head 41B through the first recovery sub-tank 71B, purge pressure can be applied from both the supply side and the recovery side to the ink heads.

As illustrated in FIG. 4, the ink jet printer 1 according to the present embodiment includes a pressure measurement apparatus 1S. The pressure measurement apparatus 1S can measure the pressure of a plurality of pressure transmission paths that apply pressure to an object via a gas (air). In the present embodiment, the object is a liquid that comes into contact with a gas discharged from the terminal end of the pressure transmission path, particularly ink. The pressure measurement apparatus 1S includes a pressure measurement section and a switching section. Focusing on the first supply side pressure supply path P11 to the eighth supply side pressure supply path P81 (a plurality of pressure transmission paths) in FIG. 4, the pressure measurement section includes the first pressure measurement path M01 (a measurement path) having an internal space capable of receiving the gas, and the first pressure sensor 611 (a pressure sensor) for detecting the pressure in the internal space. The switching section includes the ink supply measurement valve 63. The ink supply measurement valve 63 selectively switches the connection destination of the first pressure measurement path M01 from among the first supply side pressure supply path P11 to the eighth supply side pressure supply path P81. In FIG. 4, the second pressure sensor 612, the second pressure measurement path M02, and the ink recovery measurement valve 65, and the third pressure sensor 613, the third pressure measurement path M03 and the treatment liquid measurement valve 67 also constitute the pressure measurement apparatus 1S.

Such a pressure measurement apparatus 1S enables the pressures in the pressure transmission paths to be measured by a smaller number of pressure sensors than pressure transmission paths. A predetermined pressure can be easily and stably applied to the ink in the sub-tank 7. Since the pressure is transmitted via a gas in each path, even when the liquids (ink, pre-treatment liquid, and post-treatment liquid) contained the sub-tanks 7 are different from each other, the likelihood of mixing between these liquids can be reduced.

In the present embodiment, the pressure measurement apparatus 1S is mounted on the ink jet printer 1. The ink jet printer 1 includes the ink head 4 (liquid ejection section) for ejecting ink onto the workpiece W (recording material). Each of the pressure supply paths represented by the first supply side pressure supply path P11 and the first recovery side pressure supply path P12 applies the pressure to the liquids supplied to the ink head 4, the pre-treatment liquid head 5 and the post-treatment liquid head 6, or to the liquids recovered from these heads. This enables stable application of pressure to the ink in the ink head 4 and efficient measurement of the pressure.

In the present embodiment, each of the pressure transmission paths represented by the first supply side pressure supply path P11 and the first recovery side pressure supply path P12 receives pressure via air from the compressor 50 (gas pressure source) located outside the carriage 3. In other words, the first supply side pressure supply path P11 and the first recovery side pressure supply path P12 receive pressure from the compressor 50 at the first main regulator 53 and the second main regulator 54. As described above, the compressor 50 is located outside the carriage 3, so that pressure fluctuation due to movement of the carriage 3 is unlikely to occur, and the pressure can be stably applied to each head and each sub-tank 7.

Instead of the compressor 50 described above, the first main regulator 53 may receive pressure from a pump (gas pressure source), which is not illustrated, mounted on the carriage 3. In this case, the pressure transmission paths for each head can be arranged in a consolidated manner in the carriage 3.

The first upstream ink head 41A, the first downstream ink head 41B, the first supply sub-tank 71A, and the first recovery sub-tank 71B in FIG. 3 constitute the liquid ejection section of the present disclosure. The first upstream ink head 41A and first downstream ink head 41B eject yellow ink onto the workpiece W. The first supply sub-tank 71A (supply sub-tank) includes the supply tank ink region SB (first liquid region) and the supply tank gas region SA (first gas region) and supplies yellow ink to the first upstream ink head 41A and the first downstream ink head 41B. The first recovery sub-tank 71B (recovery sub-tank) includes the recovery tank ink region SD (second liquid region) and the recovery tank gas region SC (second gas region) and recovers yellow ink from the first upstream ink head 41A and the first downstream ink head 41B. The ink head, supply sub-tank and recovery sub-tank corresponding to other colors also constitute the liquid ejection section of the present disclosure.

Each supply pressure transmission path represented by the first supply side pressure supply path P11 communicates with the supply tank gas region SA of each supply sub-tank. Each recovery pressure transmission path represented by the first recovery side pressure supply path P12 communicates with the recovery tank gas region SC of each recovery sub-tank. When printing in the ink jet printer 1, the ink supply measurement valve 63 (first switching section) selectively switches the connection destination of the internal space (first internal space) of the first pressure measurement path M01 of the first pressure measurement section 1A from among the first supply side pressure supply path P11 to the eighth supply side pressure supply path P81 (a plurality of supply pressure transmission paths), and the first pressure sensor 611 of the first pressure measurement section 1A measures the pressure of the first internal space while the first internal space communicates with the supply tank gas region SA of one supply sub-tank among the plurality of liquid ejection sections. On the other hand, the ink recovery measurement valve 65 (second switching section) selectively switches the connection destination of the internal space (second internal space) of the second pressure measurement section 1B from among the first recovery side pressure supply path P12 to the eighth recovery side pressure supply path P82 (a plurality of recovery pressure transmission paths), and the second pressure sensor 612 of the second pressure measurement section 1B measures the pressure of the second internal space while the second internal space communicates with the recovery tank gas region SC of one recovery sub-tank among the plurality of liquid ejection sections.

According to this configuration, the first pressure measurement section 1A is arranged for the plurality of supply sub-tanks, and the second pressure measurement section 1B is arranged for the plurality of recovery sub-tanks. As described above, the first supply side pressure supply path P11 to the eighth supply side pressure supply path P81 are set to substantially the same pressure, and the first recovery side pressure supply path P12 to the eighth recovery side pressure supply path P82 are also set to substantially the same pressure. However, a predetermined pressure difference exists between the supply side and the recovery side to control ink ejection. In the above configuration, a large pressure difference does not occur between the connection destinations of the first pressure measurement path M01 and between the connection destinations of the second pressure measurement path M02, and the pressure fluctuation caused by the pressure difference does not hinder ink flow.

In particular, in the present embodiment, as the switching section, the dedicated ink supply measurement valve 63 is provided on the ink supply side and the dedicated ink recovery measurement valve 65 is provided on the ink recovery side. Thus, compared with the case where the supply side path and the recovery side path are respectively switched by one switching section, the pressure transmission path is not complicated, and the pressure transmission and measurement in each path can be performed stably. In another embodiment, the supply side path and the recovery side path are individually switched by one switching section as described above.

In the present embodiment, as illustrated in FIG. 4, the first pressure measurement section 1A is provided on the ink supply side and the second pressure measurement section 1B is provided on the ink recovery side. However, when the ejection of ink can be sufficiently controlled by measuring and adjusting the pressure supplied to each supply sub-tank, the pressure measurement apparatus 1S may include only the first pressure measurement section 1A and not the second pressure measurement section 1B. Similarly, when the ejection of ink can be sufficiently controlled by measuring and adjusting the pressure supplied to each recovery sub-tank, the pressure measurement apparatus 1S may include only the second pressure measurement section 1B and not the first pressure measurement section 1A. In this case, the pressure of each pressure transmission path can be stably measured while reducing the number of pressure sensors and the associated cost.

In the present embodiment, the first main regulator 53 and the second main regulator 54 illustrated in FIG. 4 function as pressure receiving sections of the present disclosure. When the ink supply measurement valve 63 switches the connection destination of the internal space of the first pressure measurement path M01 of the first pressure measurement section 1A to measure the pressure of the first supply side pressure supply path P11, for example, the first ink supply purge valve 621 opens the first supply side pressure supply path P11 and communicates with the supply tank gas region SA of the first supply sub-tank 71A and the first main regulator 53. Similarly, when the ink recovery measurement valve 65 switches the connection destination of the internal space of the second pressure measurement path M02 of the second pressure measurement section 1B to measure the pressure of the first recovery side pressure supply path P12, for example, the first ink recovery purge valve 641 opens the first recovery side pressure supply path P12 and communicates with the recovery tank gas region SC of the first recovery sub-tank 71B and the second main regulator 54. In this state, the first pressure sensor 611 and the second pressure sensor 612 measure the pressure of the first pressure measurement path M01 and the second pressure measurement path M02, respectively, and adjust the opening degrees of the first ink supply regulator 551 and the first ink recovery regulator 561 as required, thereby adjusting the pressure acting on the first supply sub-tank 71A and the first recovery sub-tank 71B.

Such a configuration enables the pressure acting on the ink in the first supply sub-tank 71A to be accurately grasped because the first pressure measurement path M01 is connected to the supply tank gas region SA of the first supply sub-tank 71A and the first ink supply regulator 551 and the pressure of the entire system for supplying ink can be comprehensively measured. The same applies to the second pressure measurement path M02.

The first pressure sensor 611 and the second pressure sensor 612 may simultaneously measure the pressures of the first supply sub-tank 71A and the first recovery sub-tank 71B, respectively. That is, the first ink supply measurement valve 631 of the ink supply measurement valve 63 connects the first pressure measurement path M01 (first internal space) of the first pressure measurement section 1A to the first supply side pressure supply path P11, and while the first internal space communicates with the supply tank gas region SA of the first supply sub-tank 71A, the first pressure sensor 611 of the first pressure measurement section 1A may measure the pressure of the first internal space. The first ink recovery measurement valve 651 of the ink recovery measurement valve 65 connects the second pressure measurement path M02 (second internal space) of the second pressure measurement section 1B to the first recovery side pressure supply path P12, and while the second internal space communicates with the recovery tank gas region SC of the first recovery sub-tank 71B, the second pressure sensor 612 of the second pressure measurement section 1B may measure the pressure of the second internal space.

According to this configuration, since the pressure on the supply side and the pressure on the recovery side are simultaneously measured for the same liquid ejection section, the effective measurement accuracy can be enhanced.

In FIG. 4, preferably, the volume of the first pressure measurement path M01 of the first pressure measurement section 1A is set to be not more than the volume of the first supply sub-tank 71A, and further not more than 0.5 times the volume of the first supply sub-tank 71A. Such a configuration enables accurate measurement of the pressure of the first supply sub-tank 71A by the first pressure sensor 611 measuring the pressure of the first pressure measurement path M01.

More preferably, the volume of the first pressure measurement path M01 of the first pressure measurement section 1A is set to be not more than the volume of the supply tank gas region SA of the first supply sub-tank 71A, and further not more than 0.5 times the volume of the supply tank gas region SA. Such a configuration enables further accurate measurement of the pressure of the first supply sub-tank 71A by the first pressure sensor 611 measuring the pressure of the first pressure measurement path M01.

In FIG. 4, preferably, the volume of the second pressure measurement path M02 of the second pressure measurement section 1B is set to be not more than the volume of the first recovery sub-tank 71B, and further not more than 0.5 times the volume of the first recovery sub-tank 71B. Such a configuration enables accurate measurement of the pressure of the first recovery sub-tank 71B by the second pressure sensor 612 measuring the pressure of the second pressure measurement path M02.

More preferably, the volume of the second pressure measurement path M02 of the second pressure measurement section 1B is set to be not more than the volume of the recovery tank gas region SC of the first recovery sub-tank 71B, and further not more than 0.5 times the volume of the recovery tank gas region SC. Such a configuration enables further accurate measurement of the pressure of the first recovery sub-tank 71B by the second pressure sensor 612 measuring the pressure of the second pressure measurement path M02.

In particular, when a volume relation exists such as above, once the pressure measurement path is switched by the ink supply measurement valve 63 and the ink recovery measurement valve 65, the pressure fluctuation in each head or sub-tank 7 hardly occurs due to the pressure difference between the sub-tank 7 that communicates with the first pressure measurement path M01 or the second pressure measurement path M02 immediately before the switching and the sub-tank 7 that communicates with the first pressure measurement path M01 or the second pressure measurement path M02 immediately after the switching.

In the present embodiment, as illustrated in FIGS. 2 and 4, the pressure in the pressure transmission path connecting to the ink head 4 (ink ejection section), the pre-treatment liquid head 5 (pre-treatment liquid ejection section), and the post-treatment liquid head 6 (post-treatment liquid ejection section) can be accurately measured by the first pressure measurement section 1A, the second pressure measurement section 1B, and the third pressure measurement section 1C, respectively. Thus, the amount of the pre-treatment liquid, ink, and post-treatment liquid landing on the workpiece W in order can be stably controlled.

Note that a filter may be placed between the supply tank gas region SA of the first supply sub-tank 71A in the first supply side pressure supply path P11 and the first pressure measurement path M01 of the first pressure measurement section 1A. In this case, the likelihood of mixing of the ink and the pre-treatment liquid can be reduced. When the ink and the pre-treatment liquid in the form of mist enter the first pressure measurement section 1A and mix, a part of the ink component may increase its viscosity by the pre-treatment liquid, or may aggregate and stick to the first pressure measurement section 1A. Such a phenomenon may reduce the measurement accuracy or cause an error in measurement. The placement of the filter helps prevent mist larger than the opening of the filter from entering, and mist smaller than the opening of the filter can be prevented from entering due to the mist hitting a place other than the opening of the filter. For the same reason, a filter may be arranged between the recovery tank gas region SC of the first recovery sub-tank 71B in the first recovery side pressure supply path P12 and the second pressure measurement path M02 of the second pressure measurement section 1B. The same applies to the other sub-tanks 7.

In the present embodiment, as illustrated in FIG. 4, the first pressure measurement section 1A exclusively measures the pressure in the pressure transmission path of the supply system and the second pressure measurement section 1B exclusively measures the pressure in the pressure transmission path of the recovery system. However, in another embodiment, the switching section (valve, not illustrated) selectively switches the connection destination of the first pressure measurement path M01 of the first pressure measurement section 1A from among the first supply side pressure supply path P11 and the first recovery side pressure supply path P12, and while the first pressure measurement path M01 communicates with the supply tank gas region SA of the first supply sub-tank 71A or the recovery tank gas region SC of the first recovery sub-tank 71B, the first pressure sensor 611 may measure the pressure of the first pressure measurement path M01. In this case, one first pressure sensor 611 can sequentially measure the pressure of the first supply sub-tank 71A and the first recovery sub-tank 71B corresponding to the same ink color. Preferably, the pressure resistance performance of the first pressure sensor 611 is set high so that the pressure difference between the first supply sub-tank 71A and the first recovery sub-tank 71B can be accommodated. In the present embodiment, the third pressure sensor 613 in FIG. 4 can sequentially measure the pressure of the supply sub-tank and the recovery sub-tank of the pre-treatment liquid and the post-treatment liquid. This is because the pressure set values of these sub-tanks are similar.

The ink jet printer 1 according to the present embodiment has the following configuration. The ink jet printer 1 includes the carriage 3 and the workpiece conveyance section 20. As illustrated in FIG. 4, the ink jet printer 1 also includes the first main regulator 53 (first pressure receiving section) and a second main regulator 54 (second pressure receiving section), which are arranged outside the carriage 3. The carriage 3 includes the first supply sub-tank 71A and the first recovery sub-tank 71B. A part of the ink sent from the supply tank ink region SB of the first supply sub-tank 71A to the first upstream ink head 41A and first downstream ink head 41B is ejected from each head and the other part is sent to the recovery tank ink region SD of the first recovery sub-tank 71B. The first main regulator 53 is connected to the supply tank gas region SA of the first supply sub-tank 71A via air (gas), and the pressure received by the first main regulator 53 from the compressor 50 applies pressure to the supply tank ink region SB via the supply tank gas region SA. Similarly, the second main regulator 54 is connected to the recovery tank gas region SC of the first recovery sub-tank 71B via air, and the pressure received by the second main regulator 54 applies pressure to the recovery tank ink region SD via the recovery tank gas region SC.

According to this configuration, the first ink supply regulator 551 can apply a desired pressure to the supply tank ink region SB (ink layer) of the first supply sub-tank 71A. Similarly, the first ink recovery regulator 561 can apply a desired pressure to the recovery tank ink region SD of the first recovery sub-tank 71B. The difference between the pressure applied to the supply tank ink region SB (ink layer) of the first supply sub-tank 71A and the pressure applied to the recovery tank ink region SD (ink layer) of the first recovery sub-tank 71B enables the supply and recovery of ink to each ink head.

Since the carriage 3 reciprocates during printing as described above, when pressure is applied from outside the carriage, the extra pressure is applied to the medium mediating the pressure from outside the carriage due to acceleration at the time of acceleration or deceleration, and the pressure tends to fluctuate. However, in the present embodiment, since the pressure is applied through a gas as the medium, the pressure fluctuation caused by the acceleration as described above is reduced.

Note that even in the above configuration, the pressure receiving section as exemplified by the first main regulator 53 and the second main regulator 54 may be one. As illustrated in FIGS. 5 and 6, each ink is circulated between the ink heads, the supply sub-tank, and the recovery sub-tank, but a configuration without circulation may be used. In addition, the sub-tank may be provided only for supply. At least one of the supply side or the recovery side may be configured to transmit pressure via a gas from the outside of the carriage 3. One of the supply side or the recovery side to which the above configuration is not applied may allow pressure fluctuation, or may include a pressure receiving section on the carriage 3.

In the present embodiment, the first ink supply regulator 551 (first adjustment section) is arranged in the middle of the first supply side pressure supply path P11 which transmits pressure by air by connecting the first main regulator 53 and the supply tank gas region SA of the first supply sub-tank 71A. The first pressure sensor 611 measures the pressure in the portion of the first supply side pressure supply path P11 that is closer to the first supply sub-tank 71A than the first ink supply regulator 551.

According to this configuration, the pressure acting on the ink of the supply tank ink region SB via the supply tank gas region SA of the first supply sub-tank 71A can be controlled by adjusting the first ink supply regulator 551 based on the measurement result of the first pressure sensor 611. In this case, the first ink supply regulator 551 may be adjusted by adding the measurement result of the second pressure sensor 612 to the measurement result of the first pressure sensor 611.

Similarly, in the present embodiment, the first ink recovery regulator 561 (second adjustment section) is arranged in the middle of the first recovery side pressure supply path P12 which transmits pressure by air by connecting the second main regulator 54 and the recovery tank gas region SC of the first recovery sub-tank 71B. The second pressure sensor 612 measures the pressure in the portion of the first recovery side pressure supply path P12 that is closer to the first recovery sub-tank 71B than the first ink recovery regulator 561.

According to this configuration, the pressure acting on the ink of the recovery tank ink region SD via the recovery tank gas region SC of the first recovery sub-tank 71B can be controlled by adjusting the first ink recovery regulator 561 based on the measurement result of the second pressure sensor 612. In this case, the first ink recovery regulator 561 may be adjusted by adding the measurement result of the first pressure sensor 611 to the measurement result of the second pressure sensor 612. The same applies to inks of the other colors.

As illustrated in FIG. 4, the adjustment sections represented by the first ink supply regulator 551 and the first ink recovery regulator 561 are not limited to those arranged outside the carriage 3, and may be mounted on the carriage 3. When these adjustment sections are mounted on the carriage 3, the number of pneumatic tubes for pressure adjustment from the main body side can be one regardless of the number of colors. On the other hand, when these adjustment sections are arranged outside the carriage 3, weight reduction and compactness of the carriage 3 can be achieved.

The present disclosure is not limited to the above-described embodiments, and the following configurations can be taken.
(1) The ink heads 4 are not limited to those arranged in two rows in the carriage 3. The ink heads 4 may be in one row or three or more rows. The ink jet printer 1 is not limited to a configuration capable of ejecting ink of a plurality of colors onto the workpiece W, but may be a configuration capable of ejecting ink of a single color.
(2) In the above-described embodiments, the ink jet printer 1 need not include the pre-treatment liquid head 5 ejecting the pre-treatment liquid, a post-treatment liquid head 6 ejecting the post-treatment liquid, and members related thereto. An aspect may be used on which at least one of the pre-treatment liquid or the post-treatment liquid has no recovery tank.
(3) The plurality of configurations disclosed in the above-described embodiments can be combined with each other to constitute one disclosure.

1. A pressure measurement apparatus for measuring a pressure in a plurality of pressure transmission paths that apply pressure to an object via a gas, the pressure measurement apparatus comprising:
at least one pressure measurement section comprising a measurement path with an internal space configured to receive the gas, and a pressure sensor configured to detect a pressure in the internal space; and
at least one switching section configured to selectively switch a connection destination of the measurement path from among the plurality of pressure transmission paths.

2. The pressure measurement apparatus according to claim 1, wherein
the object is a liquid that comes into contact with the gas discharged from a terminal end of each of the plurality of pressure transmission paths.

3. A recording apparatus, comprising:
the pressure measurement apparatus according to claim 2:
the plurality of pressure transmission paths; and
at least one liquid ejection section configured to eject a liquid onto a recording material, wherein
each of the plurality of pressure transmission paths is configured to apply the pressure to the liquid that is supplied to or recovered from the at least one liquid ejection section.

4. The recording apparatus according to claim 3, further comprising:
a carriage configured to support the at least one liquid ejection section and reciprocate in a main scanning direction, wherein
the plurality of pressure transmission paths are configured to receive pressure via the gas from at least one gas pressure source disposed outside the carriage.

5. The recording apparatus according to claim 3, further comprising:
a carriage configured to support the at least one liquid ejection section and reciprocate in a main scanning direction,
wherein
the plurality of pressure transmission paths are configured to receive pressure via the gas from a gas pressure source mounted on the carriage.

6. The recording apparatus according to claim 3, wherein the at least one liquid ejection section comprises a plurality of liquid ejection sections, each comprising a liquid ejection head configured to eject the liquid onto the recording material, a supply sub-tank, having a first liquid region and a first gas region inside and configured to supply the liquid to the liquid ejection head, and a recovery sub-tank, having a second liquid region and a second gas region inside and configured to recover the liquid from the liquid ejection head,
the plurality of pressure transmission paths comprise:
a plurality of supply pressure transmission paths, each communicating with the first gas region of each supply sub-tank of the plurality of liquid ejection sections; and
a plurality of recovery pressure transmission paths, each communicating with the second gas region of each recovery sub-tank of the plurality of liquid ejection sections,
the at least one pressure measurement section comprises a first pressure measurement section and a second pressure measurement section,
the at least one switching section is configured to selectively switch the connection destination of a first internal space, as the internal space of the first pressure measurement section, from among the plurality of supply pressure transmission paths, and while the first internal space communicates with the first gas region of the supply sub-tank of one of the plurality of liquid ejection sections, the pressure sensor of the first pressure measurement section measures the pressure in the first internal space, and
the at least one switching section is configured to selectively switch the connection destination of a second internal space, as the internal space of the second pressure measurement section, from among the plurality of recovery pressure transmission paths, and while the second internal space communicates with the second gas region of the recovery sub-tank of one of the plurality of liquid ejection sections, the pressure sensor of the second pressure measurement section measures the pressure in the second internal space.

7. The recording apparatus according to claim 6, wherein
the at least one switching section comprises a first switching section and a second switching section,
the first switching section is configured to selectively switch the connection destination of the first internal space of the first pressure measurement section, from among the plurality of supply pressure transmission paths, and while the first internal space communicates with the first gas region of the supply sub-tank of one of the plurality of liquid ejection sections, the pressure sensor of the first pressure measurement section measures the pressure in the first internal space, and
the second switching section is configured to selectively switch the connection destination of the second internal space of the second pressure measurement section, from among the plurality of recovery pressure transmission paths, and while the second internal space communicates with the second gas region of the recovery sub-tank of one of the plurality of liquid ejection sections, the pressure sensor of the second pressure measurement section measures the pressure in the second internal space.

8. The recording apparatus according to claim 3, wherein
the at least one liquid ejection section comprises a plurality of liquid ejection sections, each comprising a liquid ejection head configured to eject the liquid onto the recording material, and a supply sub-tank having a first liquid region and a first gas region inside and configured to supply the liquid to the liquid ejection head,
the plurality of pressure transmission paths comprise a plurality of supply pressure transmission paths, each communicating with the first gas region of each supply sub-tank of the plurality of liquid ejection sections,
the at least one switching section is configured to selectively switch the connection destination of the internal space of the at least one pressure measurement section, from among the plurality of supply pressure transmission paths, and while the internal space communicates with the first gas region of the supply sub-tank of one of the plurality of liquid ejection sections, the pressure sensor measures the pressure in the internal space.

9. The recording apparatus according to claim 3, wherein
the at least one liquid ejection section comprises a plurality of liquid ejection sections, each comprising a liquid ejection head configured to eject the liquid onto the recording material, and a recovery sub-tank having a second liquid region and a second gas region inside and configured to supply the liquid to the liquid ejection head,
the plurality of pressure transmission paths comprise a plurality of recovery pressure transmission paths, each communicating with the second gas region of each recovery sub-tank of the plurality of liquid ejection sections,
the at least one switching section is configured to selectively switch the connection destination of the internal space of the at least one pressure measurement section, from among the plurality of recovery pressure transmission paths, and while the internal space communicates with the second gas region of the recovery sub-tank of one of the plurality of liquid ejection sections, the pressure sensor measures the pressure in the internal space.

10. The recording apparatus according to claim 3, wherein
the at least one liquid ejection section comprises a liquid ejection head configured to eject the liquid onto the recording material, a supply sub-tank, having a first liquid region and a first gas region inside and configured to supply the liquid to the liquid ejection head, and a recovery sub-tank having a second liquid region and a second gas region inside and configured to recover the liquid from the liquid ejection head,
the plurality of pressure transmission paths comprise
at least one supply pressure transmission path communicating with the first gas region of the supply sub-tank of the at least one liquid ejection section, and
at least one recovery pressure transmission path communicating with the second gas region of the recovery sub-tank of the at least one liquid ejection section, and
the at least one switching section is configured to selectively switch the connection destination of the internal space of the at least one pressure measurement section, from among the at least one supply pressure transmission path or the at least one recovery pressure transmission path, and while the internal space communicates with the first gas region of the supply sub-tank or the second gas region of the recovery sub-tank of the at least one liquid ejection section, the pressure sensor measures the pressure in the internal space.

11. The recording apparatus according to claim 6, wherein
each of the plurality of pressure transmission paths comprises a pressure receiving section configured to receive pressure from a gas pressure source via a gas,
the at least one switching section is configured to selectively switch the connection destination of the first internal space of the first pressure measurement section, from among the plurality of supply pressure transmission paths, and while the first internal space communicates with the first gas region of the supply sub-tank of one of the plurality of liquid ejection sections and the pressure receiving section, the pressure sensor of the first pressure measurement section measures the pressure in the first internal space, and
the at least one switching section is configured to selectively switch the connection destination of the second internal space of the second pressure measurement section from among the plurality of recovery pressure transmission paths, and while the second internal space communicates with the second gas region of the recovery sub-tank of one of the plurality of liquid ejection sections and the pressure receiving section, the pressure sensor of the second pressure measurement section measures the pressure in the second internal space.

12. The recording apparatus according to claim 3, wherein
the at least one liquid ejection section comprises a liquid ejection head configured to eject the liquid onto the recording material, a supply sub-tank, having a first liquid region and a first gas region inside and configured to supply the liquid to the liquid ejection head, and a recovery sub-tank having a second liquid region and a second gas region inside and configured to recover the liquid from the liquid ejection head,
the plurality of pressure transmission paths comprise
a supply pressure transmission path communicating with the first gas region of the supply sub-tank, and
a recovery pressure transmission path communicating with the second gas region of the recovery sub-tank,
the at least one pressure measurement section comprises a first pressure measurement section and a second pressure measurement section,
the at least one switching section is configured to connect a first internal space, as the internal space of the first pressure measurement section, to the supply pressure transmission path, and while the first internal space communicates with the first gas region of the supply sub-tank, the pressure sensor of the first pressure measurement section measures the pressure in the first internal space, and the at least one switching section is configured to connect a second internal space as the internal space of the second pressure measurement section, to the recovery pressure transmission path, and while the second internal space communicates with the second gas region of the recovery sub-tank, the pressure sensor of the second pressure measurement section measures the pressure in the second internal space, simultaneously with the measurement of the pressure in the first internal space by the pressure sensor of the first pressure measurement section.

13. The recording apparatus according to claim 6, wherein
the volume of the first internal space of the first pressure measurement section is set to not more than the volume of the supply sub-tank.

14. The recording apparatus according to claim 6, wherein
the volume of the second internal space of the second pressure measurement section is set to not more than the volume of the recovery sub-tank.

15. The recording apparatus according to claim 6, wherein
the volume of the first internal space of the first pressure measurement section is set to not more than the volume of the first gas region of the supply sub-tank.

16. The recording apparatus according to claim 6, wherein
the volume of the second internal space of the second pressure measurement section is set to not more than the volume of the second gas region of the recovery sub-tank.

17. The recording apparatus according to claim 6, wherein
the at least one liquid ejection section comprises
an ink ejection section configured to eject ink as the liquid,
a pre-treatment liquid ejection section configured to eject a pre-treatment liquid as the liquid, and
a post-treatment liquid ejection section configured to eject a post-treatment liquid as the liquid.

18. The recording apparatus according to claim 6, further comprising:
a filter disposed between the first gas region of the supply sub-tank and the first internal space of the first pressure measurement section in the supply pressure transmission path.

19. The recording apparatus according to claim 6, further comprising:
a filter disposed between the second gas region of the recovery sub-tank and the second internal space of the second pressure measurement section in the recovery pressure transmission path.
